(19) United States
(12) Patent Application Publication
(10) Pub. No.: US 2003/0086121 A1
(43) Pub. Date: May 8, 2003

(54) Method for producing and selling printing ingredient or a refill kit of a printer

(76) Inventor: Chih-Ching Chen, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/682,939

(22) Filed: Nov. 2, 2001

(51) Int. Cl. B41F 1/00; G06F 15/00

(52) U.S. Cl. 358/1.18; 358/1.14

(57) ABSTRACT

A method for producing or selling printing ingredient or refill kits of a printer. The printer is manufactured by an original company and includes a housing, an ingredient cartridge installed inside the housing, and a control circuit for controlling operations of the printer. The method includes selling printer with authorization of the original company; producing or selling printing ingredient or refill kits with authorization of the original company for refilling the ingredient cartridge; and restricting other companies without authorization from the original company from producing or selling printing ingredient or refill kits.

### BACKGROUND OF INVENTION

1. Field of the Invention

The invention relates to a computer printer, and more particularly, to a method for producing and selling printing ingredient or a refill kit of a printer.

2. Description of the Prior Art

As computers have become an everyday part of our lives, so have computer printers. In many cases the most convenient form to see information is not on a computer screen but on a printed sheet of paper. The two main types of computer printers are inkjet printers and laser printers. Each of these printers uses an ingredient cartridge to make printed images on paper. The printing ingredient used in inkjet printers is ink. The printing ingredient used in laser printers is referred to as toner. As printers are used, the ink or toner in their ingredient cartridges is used up. This leaves the consumer with the option of buying a new ingredient cartridge or refilling the existing ingredient cartridge using a refill kit. According to the prior art, the most inexpensive remedy for an empty ingredient cartridge is to refill it. Because the refill kit is typically much smaller and less complicated than an ingredient cartridge, it is also much less expensive. Thus, when a refill is available for one's ingredient cartridge, buying a refill is a viable alternative.

Please refer to FIG. 1 of a perspective view of an inkjet printer ingredient cartridge refill system 8 according to the prior art. A consumer's pair of hands 10 holds an ingredient cartridge 12 and an ink refill bottle 16. The ink refill bottle 16 has an opening 18 through which ink can come out. Likewise, the ingredient cartridge 12 has an opening 14 through which ink can be poured in. To refill the ingredient cartridge 12, the ink refill bottle 16 is positioned such that its opening 18 is directly over the opening 14 of the ingredient cartridge 12. The ink refill bottle 16 is then squeezed until the ingredient cartridge 12 is refilled. Because the system 8 only works for ingredient cartridges 12 of inkjet printers, a different system was devised for ingredient cartridges of laser printer.

Please refer to FIG. 2 of a perspective view of a laser printer ingredient cartridge refill system 19 according to the prior art. A laser printer cartridge refill pack 20 is lifted above an ingredient cartridge 22. The refill pack 20 is lowered, such that it is surrounded on three sides by the locking tabs 24 on the ingredient cartridge 22. Once the refill pack 20 is lowered sufficiently, the locking tabs 24 lock the refill pack 20 against the ingredient cartridge 22. No toner will be transferred until a refill pack seal 26 and a cartridge cover 28 are opened. By pulling on the refill pack seal 26, the cartridge cover 28 is opened along with the refill pack seal 26, beginning the refilling process. Once the ingredient cartridge 22 is refilled, the refill pack 20 is removed and the cartridge cover 28 is closed again.

There are plenty of choices today when buying a new printer, and the consumer must decide from which company and which model he wishes to buy. For clarity, we will refer to a company that manufactures a printer as an original company. Although the original company manufactures the new printer, a variety of unauthorized third-party manufacturers make printing ingredient or refill kits for the original company's printers without the consent of the original company. Please refer to FIG. 3 of a flowchart of a method for producing and selling printing ingredient or refill kits according to the prior art. The method for producing and selling printing ingredient or refill kits according to the prior art comprises:

step 100:producing printers and ingredient cartridges by the original company or companies authorized by the original company;

step 102:selling printers and ingredient cartridges by the original company or companies authorized by the original company;

step 104:producing and selling printing ingredient or refill kits by unauthorized manufacturers; and

step 106:buying printing ingredient or refill kits by printer owners.

FIG. 3 provides a generalization of the printer aftermarket today. Notice that the consumer is not restricted to buying printing ingredient and refill kits solely from the original company that produced his printer. This allows unauthorized third-party manufacturers to produce or sell printing ingredient and refill kits for any printer on the market. The lack of any restrictions on which company can produce or sell printing ingredient and refill kits is a serious shortcoming of this method. Under this method, the original company receives no royalties or licensing fees when a third-party manufacturer produces or sells printing ingredient or refill kits compatible with the original company's printers.

### SUMMARY OF INVENTION

It is therefore a primary objective of the claimed invention to provide a method for producing or selling printing ingredient or refill kits of a printer to solve the above-mentioned problem.

According to the claimed invention, an original company manufactures the printer, the printer comprising a housing, an ingredient cartridge installed inside the housing, and a control circuit for controlling the operations of the printer. The method for producing or selling the printing ingredient or refill kits comprises producing and selling the printer with authorization from the original company and producing or selling the printing ingredient or refill kits with authorization from the original company, furthermore, and also restricting other companies without authorization from the original company from producing or selling printing ingredient or refill kits. As stated above, the printing ingredient is ink for inkjet printers and toner for laser printers.

It is an advantage of the claimed invention that the method for producing or selling printing ingredient or refill kits avoids potential financial problems. Under the claimed invention, the intellectual property of the original company would be given greater protection because only the original company or an authorized OEM would be allowed to produce and sell the printing ingredient or refill kits used to refill ingredient cartridges. In order to be authorized, an OEM would have to receive authorization from the original company first. This would provide financial compensation for the original company's intellectual property in the form of increased revenue, licensing fees, or royalties.

These and other objectives and advantages of the present invention will no doubt become obvious to those of ordinary skill in the art after having read the following detailed description of the preferred embodiment that is illustrated in the following drawing.

### BRIEF DESCRIPTION OF DRAWINGS

The present invention will become more fully understood from the detailed description given herein below. The following figures are illustrations only, and thus are not limitative of the present invention, and wherein:

FIG. 1 is a perspective view of an inkjet printer ingredient cartridge refill system according to the prior art.

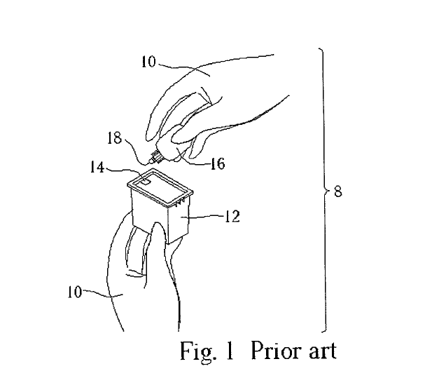

FIG. 2 is a perspective view of a laser printer ingredient cartridge refill system according to the prior art.

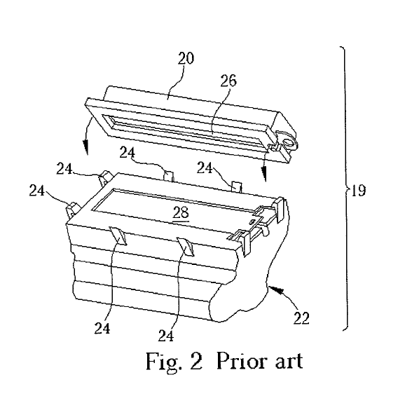

FIG. 3 is a flowchart of a method for producing and selling printing ingredient or refill kits according to the prior art.

FIG. 4 is a flowchart of a method for producing and selling printing ingredient or refill kits according to the present invention.

### DETAILED DESCRIPTION

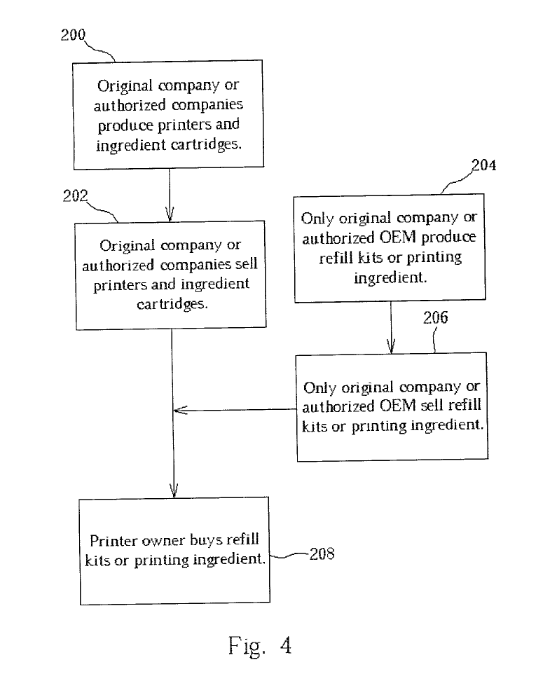

The present invention is not limited to a specific embodiment illustrated herein. Please refer to FIG. 4 of a flowchart of a method for producing and selling printing ingredient or refill kits according to the present invention. For clarity, we will refer to a company that manufactures a printer as an original company and the printer is manufactured by an original company and comprises a housing, an ingredient cartridge installed inside the housing, and a control circuit for controlling the operations of the printer.

In addition, the refill kit is used for refilling printing ingredient into an ingredient cartridge of a printer. Usually, the refill kit includes printing ingredient and refill tools helping printer owners to refill printing ingredient into the existing ingredient cartridges.

The method for producing and selling printing ingredient or refill kits comprises:

step 200:producing printers and ingredient cartridges by the original company or companies authorized by the original company;

step 202:selling printers and ingredient cartridges by the original company or companies authorized by the original company;

step 204:producing printing ingredient or refill kits only by the original company or companies authorized by the original company;

step 206:selling printing ingredient or refill kits only by the original company or companies authorized by the original company;

step 208:buying printing ingredient or refill kits by printer owners.

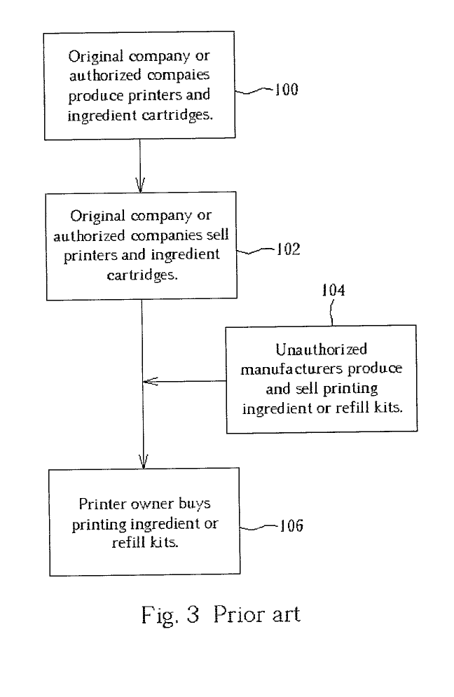

Notice that FIGS. 3 and 4 are similar in many respects. In fact there is only one major difference between the two flowcharts. According to the previous art (see FIG. 3 steps 104 and 106), any unauthorized third-party manufacturers could produce printing ingredient or refill kits and sell them directly to consumers. As stated above, this is the main shortcoming of the previous art.

A solution for the shortcoming of the prior art is presented in FIG. 4. As stated in steps 204 and 206, only the original company or an authorized OEM would be permitted to produce and sell printing ingredient and refill kits, other companies without the authorization of the original company are not allowed to produce and sell printing ingredient or refill kits. As shown in step 208, the consumer would then be able to buy only the printing ingredient or refill kits that the original company or authorized OEM produced. This would ultimately give the original company crucial protection on its intellectual property.

However, the refill tools manufactured by original company or by an authorized OEM are specifically designed for the original company's ingredient cartridges. Thus, it makes it easier for the printer owners to refill printing ingredient into the existing ingredient cartridges even without destroying the cartridges. Besides, the original company or an authorized OEM can provide the printing ingredient with the same quality to printer owners who buy the refill kits. For the reasons mentioned above, the printer owners will have much better motives to purchase the printing ingredient or refill kits including printing ingredient and refill tools manufactured by the original company or by an authorized OEM.

Sometimes, the original company's warranty doesn't cover the printers that are damaged by using an unauthorized third-party manufacturers' printing ingredient. Thus, buying and using the printing ingredient manufactured by the original company or an authorized OEM can avoid these disadvantages. Furthermore, it also can protect the original company's goodwill in printers from the printers damaged by using an unauthorized third-party manufacturers' printing ingredient.

It should be noted that application of the present invention is not confined to a laser type printer and an inkjet type printer but also has applicability to other types of printers, such as, thermal printers, laser type or inkjet type facsimile machines and multi-functional printers (MFP).

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for selling printing ingredient of a printer, the printer being manufactured by an original company and comprising a housing, an ingredient cartridge installed inside the housing, and a control circuit for controlling operations of the printer, the method comprising:
selling the printer with authorization of the original company; and
selling printing ingredient with authorization of the original company for refilling the ingredient cartridge.

2. The method of claim 1 further comprising restricting other companies without authorization from the original company from selling printing ingredient.

3. The method of claim 1 wherein the printer is a laser printer, and the printing ingredient is toner.

4. The method of claim 1 wherein the printer is an inkjet printer, and the printing ingredient is ink.

5. The method of claim 1 wherein the printing ingredient used to refill the ingredient cartridge is produced by the original company.

6. The method of claim 1 wherein the printing ingredient used to refill the ingredient cartridge is produced by other companies with authorization from the original company.

7. The method of claim 6 further comprising restricting other companies without authorization from the original company from producing the printing ingredient.

8. The method of claim 1 wherein the ingredient cartridge is refilled with the printing ingredient by using a refill tool.

9. The method of claim 8 further comprising restricting other companies without authorization from the original company from selling the refill tool.

10. The method of claim 8 wherein the refill tool is sold with the printing ingredient.

11. The method of claim 8 wherein the refill tool is manufactured by the original company.

12. The method of claim 8 wherein the refill tool is manufactured by other companies with authorization from the original company.

13. The method of claim 12 further comprising restricting other companies without authorization from the original company from producing the refill tool.

14. A method for selling a refill tool used for refilling printing ingredient into an ingredient cartridge of a printer, the printer being manufactured by an original company, the method comprising:
selling the printer with authorization of the original company; and
selling the refill tool with authorization of the original company.

15. The method of claim 14 further comprising restricting other companies without authorization from the original company from selling the refill tool.

16. The method of claim 14 wherein the refill tool is manufactured by the original company.

17. The method of claim 14 wherein the refill tool is manufactured by other companies with authorization from the original company.

18. The method of claim 17 further comprising restricting other companies without authorization from the original company from producing the refill tool.

19. The method of claim 14 wherein the printer is a laser printer, and the printing ingredient is toner.

20. The method of claim 14 wherein the printer is an inkjet printer, and the printing ingredient is ink.

21. The method of claim 14 wherein the printing ingredient is sold with the refill tool.

22. The method of claim 14 further comprising selling printing ingredient with authorization of the original company for refilling the ingredient cartridge.

23. The method of claim 22 further comprising restricting other companies without authorization from the original company from selling printing ingredient.

24. The method of claim 22 wherein the printing ingredient used to refill the ingredient cartridge is produced by the original company.

25. The method of claim 22 wherein the printing ingredient used to refill the ingredient cartridge is produced by other companies with authorization from the original company.

26. The method of claim 25 further comprising restricting other companies without authorization from the original company from producing the printing ingredient.

27. A method for selling a refill kit including printing ingredient and a refill tool, the refill tool being used for refilling the printing ingredient into an ingredient cartridge of a printer, the printer being manufactured by an original company, the method comprising:
selling the printer with authorization of the original company; and
selling the refill kit with authorization of the original company.
